(19) United States
(12) Patent Application Publication
(10) Pub. No.: US 2017/0351531 A1
(43) Pub. Date: Dec. 7, 2017

(54) INFORMATION PROCESSING METHOD AND ELECTRONIC APPARATUS THEREOF

(71) Applicant: Lenovo (Beijing) Co., Ltd., Beijing (CN)

(72) Inventors: Hui LI, Beijing (CN); Xiaoping ZHANG, Beijing (CN); Yaqiang WU, Beijing (CN)

(21) Appl. No.: 15/616,011

(22) Filed: Jun. 7, 2017

(30) Foreign Application Priority Data
Jun. 7, 2016 (CN) 201610399544.9

(51) Int. Cl. G06F 9/44; G06F 9/54; G06F 3/0481

(52) U.S. Cl. CPC G06F 9/4445; G06F 3/0481; G06F 9/542

(57) ABSTRACT

The present disclosure provides an information processing method and an electronic apparatus thereof. The method includes using a first electronic apparatus to receive data displayed via a second electronic apparatus for a corresponding display via the first electronic apparatus; providing a status identifier to control the corresponding display of the data as received from the second electronic apparatus; and displaying the status identifier via the first electronic apparatus.

### CROSS-REFERENCES TO RELATED APPLICATIONS

This application claims priority of Chinese Patent Application No. 201610399544.9, filed on Jun. 7, 2016, the entire contents of which are hereby incorporated by reference.

### FIELD OF THE DISCLOSURE

The present disclosure relates to the field of electronic information technologies and, more particularly, relates to an information processing method and the electronic equipment thereof.

### BACKGROUND

With the development of electronic information technology, the projection of the display contents can be performed between electronic apparatuses. For example, the contents displayed on a mobile phone can be projected onto a computer. However, mere projections of the display contents may have problems such as the process not being user-friendly and being of low operating efficiency, etc.

### BRIEF SUMMARY OF THE DISCLOSURE

In view of the foregoing, embodiments of the present disclosure provide an information processing method and an electronic apparatus of the information processing method, which at least solve a part of the above problems.

One aspect of the present disclosure provides an information processing method. The method includes using a first electronic apparatus to receive data displayed via a second electronic apparatus for a corresponding display via the first electronic apparatus; providing a status identifier to control the corresponding display of the data as received from the second electronic apparatus; and displaying the status identifier via the first electronic apparatus.

The method may further include providing a first identifier of a first application executed in the second electronic apparatus as the status identifier; and displaying the first identifier via the first electronic apparatus.

The method further includes displaying the corresponding display in a first display area via the first electronic apparatus; and displaying the first identifier in a second display area via the first electronic apparatus, the first display area being different from the second display area.

Further, the second display area may be a display area for displaying an identifier of a task that the first electronic apparatus is executing.

The method may further include displaying, via the first electronic apparatus, a menu after receiving a first operation acting on the status identifier. The menu may include an application identifier of the second electronic apparatus and the application identifier may indicate an application of the second electronic apparatus.

The method may further include switching a display interface of the first electronic apparatus from the first application to a second application of the second electronic apparatus after a second operation of selecting the application identifier of the second application is detected.

The method may further include receiving a second identifier of the second application; updating the status identifier to the second identifier; and displaying the second identifier.

Another aspect of the present disclosure provides an electronic apparatus. The electronic apparatus includes a display unit; and a processor configured to receive data displayed via a remote electronic apparatus for a corresponding display via the display unit; wherein the processor is further configured to provide a status identifier to control the corresponding display of the data as received from the remote electronic apparatus, and to display the status identifier via the display unit. Further, the processor may provide a first identifier of a first application in the remote electronic apparatus as the status identifier; and the display unit may display the first identifier. The display unit may further display the corresponding display in a first display area and display the first identifier in a second display area, wherein the first display area is different from the second display area.

Further, the second display area may be a display area for displaying an identifier of a task that the electronic apparatus is executing. The display unit may display a menu after receiving a first operation acting on the status identifier. The menu may include an application identifier of the remote electronic apparatus. The application identifier may indicate an application of the remote electronic apparatus.

Further, the display unit may switch a display from the first application to a second application of the remote electronic apparatus after a second operation of selecting the application identifier of the second application is detected, wherein the second application is different from the first electronic apparatus.

Further, the processor may receive the second identifier of a second application as the status identifier; the display unit may display the second identifier.

Other aspects of the present disclosure can be understood by those skilled in the art in light of the description, the claims, and the drawings of the present disclosure.

One embodiment of the present disclosure provides an information processing method and an electronic apparatus, in which a first electronic apparatus is used to receive data displayed via a second electronic apparatus for a corresponding display via the first electronic apparatus. And a status identifier is provided to control the corresponding display of the data as received from the second electronic apparatus. Further, the status identifier is displayed via the first electronic apparatus. The status identifier, on one hand, is used to represent a current operative state of the first electronic apparatus. On the other hand, the status identifier may be used to control display of the first electronic apparatus. Such a design can use the hardware and software resources of the first electronic apparatus to enhance the intelligence of the first electronic apparatus and deliver a better user experience.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an information processing method consistent with the disclosed embodiments;

FIG. 2 is a schematic diagram of a display effect of a first electronic apparatus consistent with the disclosed embodiments;

FIG. 3 shows a schematic diagram of a display switching of the first electronic apparatus consistent with the disclosed embodiments;

FIG. 4 illustrates a schematic diagram of another display switching of the first electronic apparatus consistent with the disclosed embodiments;

FIG. 5 illustrates a schematic diagram of a connection between the first electronic apparatus and a second electronic apparatus consistent with the disclosed embodiments;

FIG. 6 is a schematic diagram of the first electronic apparatus consistent with the disclosed embodiments;

FIG. 7 shows another schematic diagram of the first electronic apparatus consistent with the disclosed embodiments; and

FIG. 8 shows another schematic diagram of the first electronic apparatus consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

### Embodiment 1

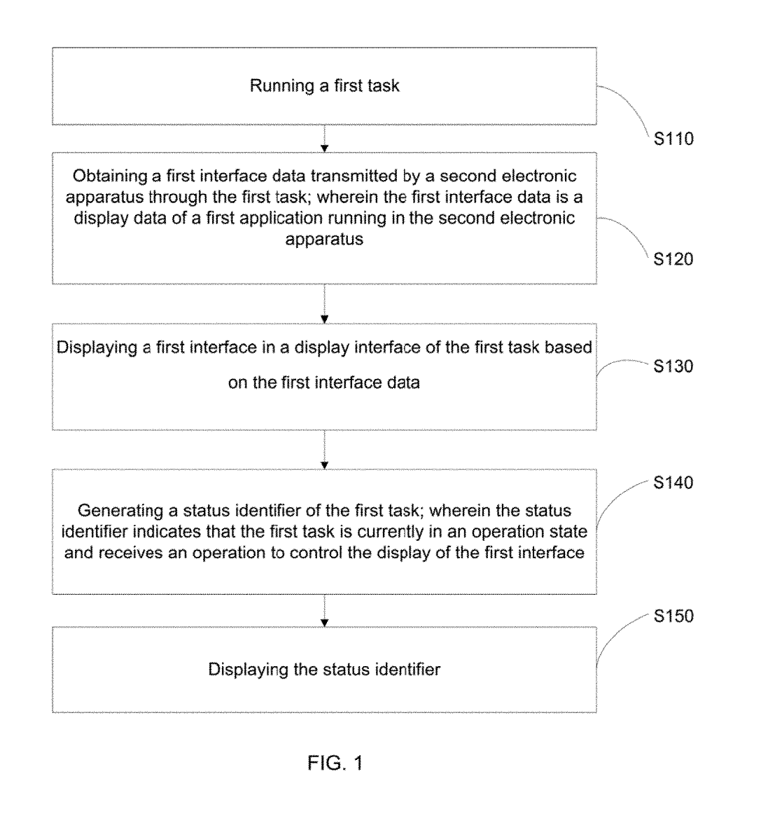

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface. In the present disclosure, a status identifier and a status bar are used interchangeably with a task identifier or a task bar. The status identifier or the task identifier may indicate the status of a task or an application. The status identifier or the task identifier may be displayed on a status bar or a task bar.

Step S150: displaying the status identifier.

The information processing method described in the present embodiment can be implemented on an electronic apparatus that receives interface data. The first electronic apparatus as identified in the present embodiment can be an electronic apparatus such as a notebook computer, a desktop computer or a tablet computer, etc. The second electronic apparatus can be a mobile phone, a wearable computing apparatus, etc.

In the present embodiment, the display area of the first electronic apparatus may be larger than the display area of the second electronic apparatus. The display area of the display interface of the first task is larger than the display area of the second electronic apparatus, and the first interface data of the second electronic apparatus is transmitted to the first electronic apparatus. Through the display of the first electronic apparatus, a full-screen enlargement of the first interface is achieved, thus improving the display effect. Of course, the first interface displayed in the display interface of the first task may be equal to or smaller than the display area of the first interface displayed by the second electronic apparatus, not limited to larger than the display area displayed by the second electronic apparatus. In some embodiments, if the display areas of the first interface are of an equal size on the first electronic apparatus and the second electronic apparatus, the area of the display interface of the first task may be smaller than the total display area of the first electronic apparatus.

Step S110 refers to executing the first task, which can be a task for triggering the first electronic apparatus to display the display interface of the second electronic apparatus. For example, a cross-screen application may be displayed in the first electronic apparatus. And if the cross-screen application is in an operational state, the first electronic apparatus automatically collects or obtains the first interface data from the second electronic apparatus, based on which the first electronic apparatus builds the display interface.

In Step S130, the first interface is displayed in the display interface of the first task based on the first interface data, and the first interface is an application interface of the first application running on the second electronic apparatus.

In Step 140, the first electronic apparatus may also generate the status identifier of the first task, and the status identifier can be used to control the display of the first interface.

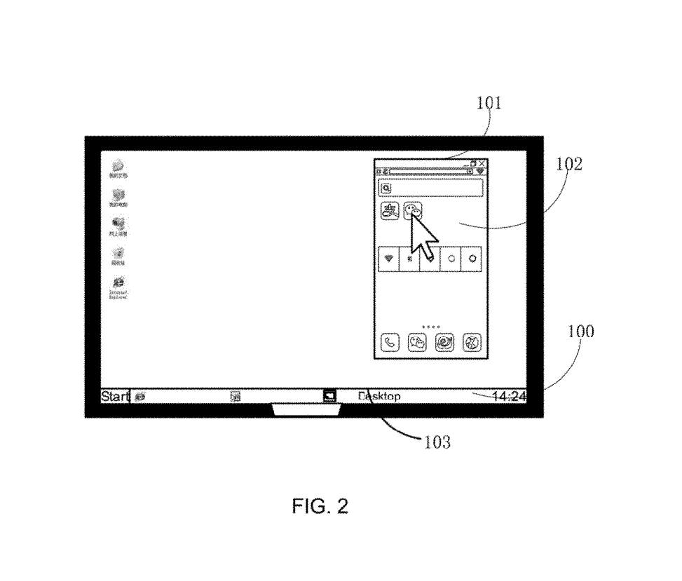

FIG. 2 illustrates a display desktop of Windows system. At the bottom of the display desktop, it shows a status bar 100. In some embodiments, the status bar 100 is used to display the minimized window of applications which the Windows system is currently running and the application icons pinned thereto. As shown in FIG. 2, the bar in which the “Start” menu is located can refer to the status bar 100. The status identifier as identified in the present embodiment can be displayed on the status bar 100, which can be used to display an identifier corresponding to the first interface currently displayed in the display interface of the first task. And the user may use a mobile phone or a manual touch, etc., by operating on the status identifier, to close the first interface or switch the display content displayed in the display interface of the first task.

As illustrated in FIG. 2, a desktop of the first electronic apparatus is displayed. The application icons of the first electronic apparatus are displayed on the left side of the desktop. FIG. 2 further shows an interface 102 of the second electronic apparatus (e.g., a mobile phone) displayed in a display interface 101 of the first task. The display interface 101 of the first task includes, in addition to the interface 102, controls that control display states of the first task, for example, a minimize control, a window zoom control and a close control. The minimize control is applied to minimize an application window of the first task to the status bar 100, the window zoom control is used to change the size of the display interface of the first task, and the close control is to turn off the first task. FIG. 2 also depicts a status identifier 103. The status identifier 103, on one hand, may indicate the current operating state of the first task. Generally, if the first task is turned on, the status identifier 103 of the first task is displayed, but if the first task is closed, the status identifier 103 is not displayed. On the other hand, the status identifier 103 in the present embodiment may not only indicate the operating state of the first task, but also may receive an operation instruction. The operation instruction may be applied to control the display state of the first interface in the display interface 101 of the first task.

The information processing method provided in the present embodiment is not limited to obtaining the first interface information from the second electronic apparatus to display. Meanwhile, it also generates the status identifier for controlling the first interface display on the first electronic apparatus. The user may control, through the status identifier, the display of the first interface, thereby increasing the user's control ability. It also makes a better use of the hardware and software resources of the first electronic apparatus, thus enhancing the usability of the second electronic apparatus. At the same time, the status identifier is implemented to characterize the current state of the first task, for example, informing the user of the first application as currently displayed in the display interface of the first task and controlling the display of the first interface. It is clear that the generation and display of such a status identifier can play multiple roles with a sophisticated design.

Although the second electronic apparatus shows fewer components, the amount of information as conveyed may be more. In the present embodiment, the status identifier may include an application identifier of the application currently displayed in the application interface of the first task. The application identifier may be any type of identifier showing information such as an icon, a text name, or the like that can be used to represent the application and its status.

### Embodiment 2

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface.

Step S150: displaying the status identifier.

Step S140 may further include receiving a first identifier of the first application as the status identifier.

Step S150 may further include displaying the first identifier.

In the present embodiment, the status identifier is a first identifier of the first application. The first identifier can be an application identifier of the first application. The application identifier may include other information that identifies the first application, such as an application icon, an application name, the same resource address URL of the application, etc. In short, the first identifier is information associated with the first application. When the first application interface of the first application is displayed by the display interface of the first task, the status identifier generated and displayed by the first electronic apparatus is the first identifier of the first application. A user can identify the first application as displayed in display interface of the first task, through the displayed status identifier, to gain better understanding of the status of the application.

For example, in FIG. 2, the status identifier 103 can be an application identifier of the interface of the second electronic apparatus (for example, mobile phone). The status identifier 103 shown in FIG. 2 may include an icon and a text identifier. In one application, the status identifier may include only an icon or a text identifier.

In the present embodiment, the status identifier 103 can be an application icon of the first interface as displayed in the display interface of the first task. In one application, the status identifier 103 may be an identifier other than the application identifier of the first application. Instead, the status identifier 103 can be, for example, an icon or a text identifier of the first task. Specifically, whether the status identifier 103 is the identifier of the first task itself or the application identifier corresponding to the application interface of the second electronic apparatus as displayed in the display interface of the first task, can be determined according to the application type corresponding to the application interface displayed in the display interface of the first task. For example, when the display interface of the first task displays the current interface of the second electronic apparatus, the status identifier 103 is preferably an identifier of the first task itself; while the display interface of the first task displays an application interface of other applications, other than the interface of the second electronic apparatus, the status identifier 103 can employ the application identifier corresponding to the application interface displayed in the display interface of the first task. For example, the status identifier 103 may include one or more attribute of the first interface.

If the attribute represents that the first application is an application, the status identifier shows the application identifier of the first application. Otherwise, the status identifier may show the identifier of the first task. For example, the attribute can be the name of the first application, while the application can be a pre-identified application. The attribute can also be a type parameter, while the application can be a predetermined type of application.

In summary, in the present embodiment, the first identifier that is used as the status identifier is only exemplary. In some embodiments, the status identifier is not limited to the application identifier of the first application.

### Embodiment 3

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface.

Step S150: displaying the status identifier.

Step S140 may further include receiving a first identifier of the first application as the status identifier.

Step S150 may further include displaying the first identifier.

In some embodiments, Step S150 may further include displaying the first interface in the first display area.

In some embodiments, Step S150 may further include displaying the first identifier in the second display area. The first display area may be different from the second display area.

In the present embodiment, the first interface is different from the display area of the first identifier. This avoids the display overlay caused by the superimposition displays, and/or the inconvenience of display controls.

In the present embodiment, the first display area and the second display area can be two different sub-regions of the display interface of the first task. In some embodiments, the first display area can be part or all region of the display interface of the first task. And the second display area can be an area other than the display interface of the first task. In such an arrangement, a change to the display interface of the first task would not affect the display of the first identifier to and the control of the first interface.

In the present embodiment, the second display area is a display area for displaying an identifier of a task the first electronic apparatus is currently executing.

For example, if the first electronic apparatus is an apparatus running the Windows operating system, the first electronic apparatus may display a status bar at the bottom of the display interface, in which the application that the first electronic apparatus is currently running is shown. In the present embodiment, the first identifier is shown on the status bar, and it is thus convenient for the user, by using the status bar, to identify the first interface as displayed in the first task. In one application, the first electronic apparatus further displays a task identifier of the first task. It also shows the task identifier and the status identifier adjacent to each other or in the same icon frame. In such an arrangement, the system enables the user through the task identifier to determine that the first task is in an operative state, and through the status identifier (such as the first identifier) to determine the first interface currently being displayed in the task interface of the first task. Such a process may provide more information to the user in the limited display area.

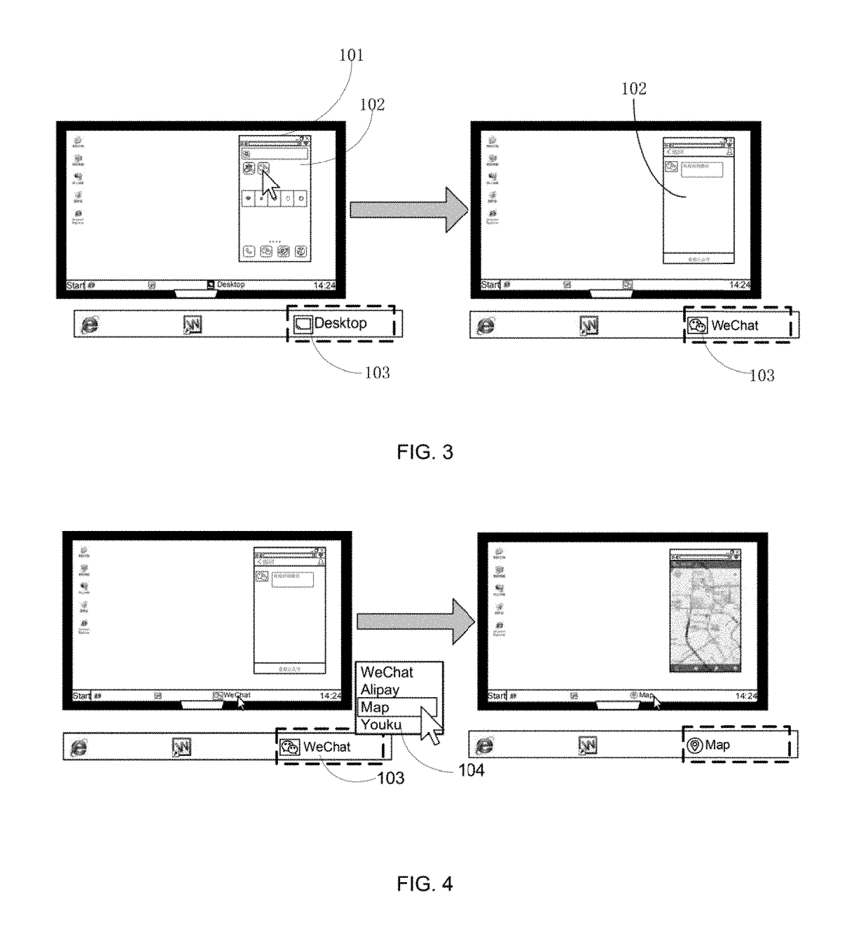

As shown in FIGS. 2 and 3, the display area of the status identifier 103 is different from the display area of the application interface 102 of the second electronic apparatus. The application interface 102 is located in the display interface of the first task, while the status identifier 103 is outside the display interface of the first task. In FIG. 3, the bar shown below the display screen is an enlarged view of the status bar in the display screen. The dashed lines frame the status identifier 103. For example, in the present embodiment, after the WeChat icon (i.e., the icon pointed by the mouse) on the user interface is clicked, the first electronic apparatus transmits an operation of clicking the WeChat icon to the mobile phone as the second electronic apparatus, and the mobile phone opens the WeChat page. WeChat is a social media (instant messaging, commerce and payment services) application developed by Tencent. The first electronic apparatus also updates the application interface 102 of the mobile phone it displays. The first interface in the display interface of the first task is changed from the user interface of the mobile phone to the WeChat interface that the mobile phone is currently running. Meanwhile, the status identifier 103 is updated to be the WeChat icon and WeChat name. The operation of clicking here may be replaced by any of the user operations. The user operations can refer to a sliding operation, a voice control operation, or the like. The user operations can also be a mouse operation, a keyboard operation, a touch operation on a touch screen. The user operations are not limited to specific operation types or specific operation modes.

### Embodiment 4

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface.

Step S150: displaying the status identifier.

As shown in FIG. 3, the method further includes displaying a menu after receiving a first operation acting on the status identifier. The menu includes at least one application identifier of the second electronic apparatus.

Further, the application identifier is at least capable of switching the application of the second electronic apparatus displayed in the display interface of the first task.

The status identifier in the present embodiment may also serve as a trigger control for the menu. A first operation can be a click operation, a sliding operation, a right-hand operation of the mouse, or the like. For example, the operation can be a right-hand click of the mouse. The first electronic apparatus may display a menu after receiving the first operation. As shown in FIG. 4, a menu is popped up above the status identifier, and one or more application identifiers of the second electronic apparatus are present in the menu. The application identifiers can be application icons, application names, or the like. In general, they are identifiers of the applications to indicate the applications in the second electronic apparatus. The application identifier can serve as a detection control to determine the application interface of which application the user is currently displaying on the first electronic apparatus.

The information processing method described in the present embodiment can be implemented in various applications based on any of the foregoing technical solutions. For example, in the present embodiment, the status identifier can likewise be a first identifier of the first application. In addition, the status identifier and the first interface may be displayed in the same display area or in different display areas. For example, the status identifier may be displayed in a second display area and the first interface is displayed in a first display area. The first display area and the second display area may be distinguished by a boundary of the display interface of the first task. That is, the second display area may be a display area other than the display interface of the first task, and the first display area may be a display area within a display interface of the first task. The second display area may also be a display area, such as an area is used to the status bar as described above.

### Embodiment 5

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface.

Step S150: displaying the status identifier.

As shown in FIG. 3, the method includes displaying a menu after receiving a first operation acting on the status identifier. The menu includes at least one application identifier of the second electronic apparatus.

The application identifier is at least capable of switching the application of the second electronic apparatus displayed in the display interface of the first task.

The method further includes switching the first interface displayed in the displace interface of the first task to the second interface of the second application after a second operation of selecting the application identifier of the second application is detected.

For example, if a QQ application interface (https://en.wikipedia.org/wiki/Tencent_QQ) is currently displayed, after an application identifier of the Alipay application (an online payment system) is clicked, the first electronic apparatus controls the display interface of the first task to switch from the QQ application interface to the Alipay application interface, enabling an easy switch of the application interface of the second electronic apparatus displayed on the first electronic apparatus.

As illustrated in FIG. 4, after the status identifier 103 is clicked, a menu 104 is displayed. The menu 104 shows application identifiers for applications in the second electronic apparatus. The application identifiers illustrated in FIG. 4 are application names. However, in some embodiments, the application identifiers can also be application icons. As illustrated, the first electronic apparatus detects an operation acting on a map application identifier on the menu 104. The application interface of the second electronic apparatus displayed in the display interface of the first task is switched from the WeChat application interface to the map application interface.

### Embodiment 6

As illustrated in FIG. 1, the present embodiment provides an information processing method applied to a first electronic apparatus, comprising the following steps.

Step S110: executing a first task.

Step S120: receiving a first interface data transmitted by a second electronic apparatus through the first task, wherein the first interface data may be display data of a first application running in the second electronic apparatus.

Step S130: displaying a first interface in a display interface of the first task based on the first interface data;

Step S140: generating a status identifier of the first task. The status identifier indicates that the first task is currently in an operative state and receives an operation to control the display of the first interface.

Step S150: displaying the status identifier.

As shown in FIG. 3, the method includes displaying a menu after receiving a first operation acting on the status identifier. The menu includes at least one application identifier of the second electronic apparatus;

The application identifier is at least capable of switching the application of the second electronic apparatus displayed in the display interface of the first task.

The method further includes switching the first interface displayed in the displace interface of the first task to the second interface of the second application after a second operation of selecting the application identifier of the second application is detected.

The method further comprises receiving the second identifier of the second application; updating the status identifier of the first task to the second identifier; and displaying the second identifier.

In the present embodiment, after the first interface displayed in the display interface of the first task is switched to the second interface, the status identifier may be updated. And after the status identifier is updated, the second identifier of the second application is obtained or received; the status identifier is updated to the second identifier; and the second identifier is displayed. It thus enables the user to easily identify, through the status identifier, the application interface displayed in the display interface of the first task.

For example, as illustrated in FIG. 4, after the application interface of the second electronic apparatus displayed in the display interface of the first task is switched from the WeChat application interface to the map application interface, the status identifier is changed to the map identifier from the WeChat identifier. The map identifier may include a map application icon and/or a map application name.

### Embodiment 7

As shown in FIGS. 6 to 8, the present embodiment provides an electronic apparatus as a first electronic apparatus. The apparatus includes a processor 110 for executing a first task and receiving or obtaining a first interface data transmitted by a second electronic apparatus through the first task. The first interface data may be display data of a first application running in the second electronic apparatus. The apparatus may further include a display unit 120 for displaying a first interface in a display interface of the first task based on the first interface data. The processor 110 is configured for generating a status identifier of the first task. The status identifier indicates that the first task is currently in an operative state and receives an operation to control the display of the first interface. The display unit 120 is configured for displaying the status identifier.

The processor 110 described in the present embodiment can be selected from a variety of information processors which include a Central Processing Unit (CPU), a microprocessor (MCU), a digital signal processor (DSP), a programmable array (PLC), an application process (AP) and other types of processors.

The display unit 120 can be selected from a variety of display units capable of displaying information, such as a liquid crystal display (LCD), an electronic ink display, a projection display, an organic light emitting diode (OLED) display, etc.

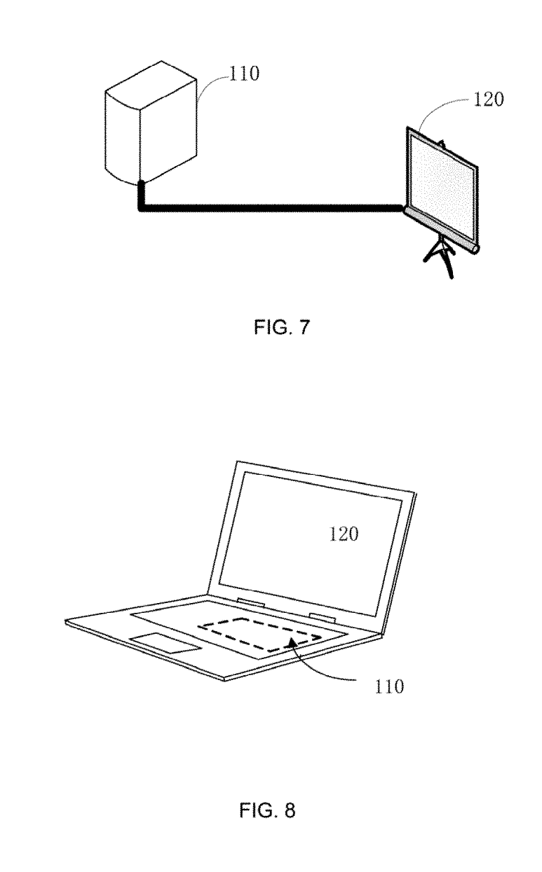

In the present embodiment, an electronic connection is provided between the processor 110 and the display unit 120, and the processor 110 can interact with the display unit 120 to control or assist a display of the display unit 120. As shown in FIG. 7, the processor 110 and the display unit 120 may be in different housings. In that case, the processor 110 and the display unit 120 may be connected by a connection line located outside the two housings. As illustrated in FIG. 8, the processor 110 and the display unit 120 can also be disposed within one housing to form an integrated apparatus of the first electronic apparatus. If the display unit 120 and the processor 110 are not integrated, the first electronic apparatus may correspond to a desktop computer. If the display unit 120 and the processor 110 are integrated within one housing, the first electronic apparatus may correspond to an electronic apparatus such as a tablet computer.

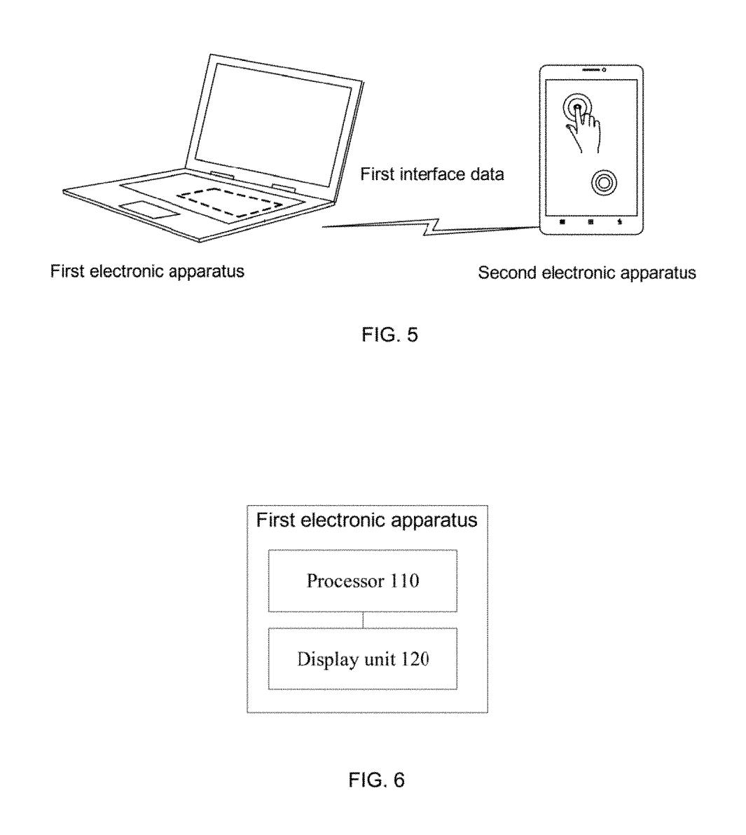

The second electronic apparatus may be an electronic apparatus separate from the first electronic apparatus, and the connection established between the second electronic apparatus and the first electronic apparatus may be wireless (e.g., a short-distance wireless connection). The so-called short-distance wireless connection herein can refer to a Bluetooth connection, an infrared connection, a WiFi connection, or the like. As shown in FIG. 5 as an example, the first electronic apparatus may be a notebook computer, and the second electronic apparatus may be a mobile phone. And a wireless connection may be established between the first electronic apparatus and the second electronic apparatus, at least for transmitting the first interface data.

In the present embodiment, a status identifier is generated after receiving the first interface data, and the display unit 120 displays the status identifier. The display of the status identifier, on one hand, informs the user of the state of the first task. On the one hand, it is also used to receive the user operation to control the display of the first interface in the display interface of the first task, accordingly making a better use of the hardware and software resources of the first electronic apparatus and enhancing the intelligence of the electronic apparatus and the user's satisfaction.

### Embodiment 8

As shown in FIGS. 6 to 8, the present embodiment provides an electronic apparatus as a first electronic apparatus. The apparatus includes a processor 110 for executing a first task and obtaining a first interface data transmitted by a second electronic apparatus through the first task; wherein the first interface data may be display data of a first application running in the second electronic apparatus; a display unit 120 for displaying a first interface in a display interface of the first task based on the first interface data. The processor 110 is configured for generating a status identifier of the first task. The status identifier indicates that the first task is currently in an operative state and receives an operation to control the display of the first interface. The display unit 120 is configured for displaying the status identifier. The processor 110 is may obtain or receive a first identifier of the first application as the status identifier; and the display unit 120 may display the first identifier.

In the present embodiment, the status identifier is the first identifier of the first application, so that the user can identify the first application displayed in the display interface of the first task according to the status identifier. Meanwhile, the status identifier also serves as a control capable of detecting a user operation, wherein the user operation can refer to a mouse operation, a keyboard operation, a touch operation, a voice operation and so forth. The display of the first interface in the display interface of the first task can be controlled by the status identifier, thus providing a user-friendly interface. Embodiments of the present disclosure use of the hardware and software of the first electronic apparatus to enhance the intelligence of the second electronic apparatus and the user experience.

### Embodiment 9

As shown in FIGS. 6 to 8, the present embodiment provides an electronic apparatus as a first electronic apparatus, including a processor 110 for executing a first task and obtaining a first interface data transmitted by a second electronic apparatus through the first task. The first interface data may be display data of a first application running in the second electronic apparatus. The apparatus may include a display unit 120 for displaying a first interface in a display interface of the first task based on the first interface data. The processor 110 is also for generating a status identifier of the first task; wherein the status identifier indicates that the first task is currently in an operative state and receives an operation to control the display of the first interface. The display unit 120 may display the status identifier; the processor 110 may obtain or receive a first identifier of the first application as the status identifier. The display unit 120 may display the first identifier. The display unit 120 may display the first interface in a first display area and display the first identifier in a second display area. The first display area is different from the second display area.

In the present embodiment, the display unit 120 may display the first identifier and the first interface in different areas. This separated display can avoid the mutual interference of the displays. In the present embodiment, the first display area can be a display area located in a display interface of the first task; and the second display area can be a display area other than the display interface of the first task. In such an arrangement, even if the first interface is closed, the first identifier can still be displayed to allow user control on the display of the display interface of the first task.

Further, the second display area may be a display area for displaying an identifier of a task that the first electronic apparatus is currently running. The second display area described in the present embodiment can correspond to a status bar in the Windows system. In this way, even when the first interface of the first application that the second electronic apparatus is currently running is displayed, the first electronic apparatus may be able to match the display style or the display mode of the first electronic apparatus. Such a configuration may provide a user-friendly operation environment to meet the first electronic apparatus operating habits, and enhance the intelligence of the second electronic apparatus and the user experience.

### Embodiment 10

As shown in FIGS. 6 to 8, the present embodiment provides an electronic apparatus as a first electronic apparatus. The first electronic apparatus includes a processor 110 for executing a first task and obtaining a first interface data transmitted by a second electronic apparatus through the first task. The first interface data may be display data of a first application running in the second electronic apparatus. The apparatus may include a display unit 120 for displaying a first interface in a display interface of the first task based on the first interface data. The processor 110 may generate a status identifier of the first task. The status identifier indicates that the first task is currently in an operative state and receives an operation to control the display of the first interface. The display unit 120 may display the status identifier. The display unit 120 may display a menu after receiving a first operation acting on the status identifier; wherein the menu includes at least one application identifier of the second electronic apparatus.

The application identifier is at least capable of switching the application of the second electronic apparatus displayed in the display interface of the first task.

In the present embodiment, the status identifier also may serve as a trigger control for triggering a menu display, and after a first operation is received, the menu may be displayed. A plurality of application identifiers may be provided in the menu, enabling the user to make use of the identifiers to switch the applications in the display interface of the first task.

The first electronic apparatus provided by the present embodiment may be implemented based on any electronic apparatus provided in the foregoing embodiments and may be combined with any of the foregoing embodiments of an electronic apparatus as needed.

### Embodiment 11

As shown in FIGS. 6 to 8, the present embodiment provides an electronic apparatus as a first electronic apparatus. The first electronic apparatus may include a processor 110 for executing a first task and obtaining a first interface data transmitted by a second electronic apparatus through the first task. The first interface data may be display data of a first application running in the second electronic apparatus. The first electronic apparatus may include a display unit 120 for displaying a first interface in a display interface of the first task based on the first interface data. The processor 110 may generate a status identifier of the first task. The status identifier may indicate that the first task is currently in an operative state and receives an operation to control the display of the first interface. The display unit 120 may display the status identifier. The display unit 120 may display a menu after receiving a first operation acting on the status identifier. The menu may include at least one application identifier of the second electronic apparatus.

The application identifier may switch the application of the second electronic apparatus displayed in the display interface of the first task.

The display unit 120 may further switch the first interface displayed in the display interface of the first task to a second interface of the second application after a second operation of selecting the application identifier of the second application is detected; wherein the second application is an application that is not currently displayed by the first electronic apparatus.

The second operation and the first operation described in the present embodiment can be the same type of operation, for example, both can be mouse click operations, or a different type of operations. In some embodiments, the first operation may act on the status identifier, while the second operation may be an application identifier that may act on the menu display. The first operation may trigger the first electronic apparatus to show the menu, while the second operation may control the switching of the application interface displayed in the display interface of the first task.

The display of the status identifier and the menu described in the present embodiment enables the switching of the application interface displayed in the display interface of the first task. Such a configuration may increase the utilization rate of the hardware and software resources of the first electronic apparatus, and improve the intelligence of the electronic apparatus and the user experience.

### Embodiment 12

As shown in FIGS. 6 to 8, the present embodiment provides an electronic apparatus as a first electronic apparatus. The first electronic apparatus may include a processor 110 for executing a first task and obtaining a first interface data transmitted by a second electronic apparatus through the first task. The first interface data may be display data of a first application running in the second electronic apparatus. The first electronic apparatus may include a display unit 120 for displaying a first interface in a display interface of the first task based on the first interface data. The processor 110 may generate a status identifier of the first task. The status identifier may indicate that the first task is currently in an operative state and receives an operation to control the display of the first interface. The display unit 120 may display the status identifier. The display unit 120 may display a menu after receiving a first operation acting on the status identifier. The menu may include at least one application identifier of the second electronic apparatus.

The application identifier may switch the application of the second electronic apparatus displayed in the display interface of the first task. The processor 110 may obtain a second identifier of the second application as the status identifier. The display unit 120 may display the second identifier.

The display unit 120 described in the present embodiment may obtain or receive the second identifier of the second application after it is detected that the first interface is switched to the second interface, and may control the status identifier to switch from the first identifier to the second identifier. This keeps the user informed of the application currently displayed in the display interface of the first task easily according to the status identifier.

In some embodiments of the present disclosure, the second electronic apparatus may be a mobile phone and the first electronic apparatus may be a personal computer (PC) providing the Windows system.

After the PC starts a cross-screen display application, the status bar displays the name and icon of the application the mobile phone is currently running, and in the display interface of the cross-screen display application, the application currently displayed on the phone may be displayed. The name and icon may be the name and icon of the application that the mobile phone is currently running in the foreground.

When a right click on the name and icon of the status bar is detected, the PC may pop up a menu or a list including a plurality of application icons of the mobile phone; and further detect an operation acting on the application icon of the menu or list. If the corresponding operation is detected, the PC display interface of the cross-screen display application may switch to a display of the mobile phone application.

In the present application, the cross-screen display application may correspond to the first task as described above. The status bar may correspond to the second display area. The name and icon may correspond to the status identifier. The menu or list may correspond to the menu. The application icon of the menu or list may correspond to the application identifier as described in the above embodiments.

For example, if the current application of the mobile phone is the Android application desktop launcher “Launcher”, the PC's status bar may show a small window of the cross-screen display application. The cross-screen display application window may display an icon of the cross-screen application itself. If the user starts the application “WeChat” on the mobile phone, the PC's status bar may display the “WeChat” text and icon. The “WeChat” text and icon may be shown in the small window of the cross-screen application.

When a user click on the window in the status bar is detected, the menu of the current task of the mobile phone may be displayed. In one example, if the user operation currently acting on the map application is detected, the display in the display interface of the PC's cross-screen display application may switch from the “WeChat” application interface to the map application interface. In one embodiment, the PC as the first electronic apparatus may also send a notification instruction to the mobile phone as the second electronic apparatus. The notification may control the foreground of the mobile phone to perform an application switch to the map application. The “WeChat” application may correspond to the first application described in some embodiments. The map application may correspond to the second application. The notification instruction may be used to control the foreground of the second electronic apparatus to perform an application switch from the first application to the second application.

From the embodiments provided herein, it can be understood that the disclosed apparatus and method may be implemented in other ways. The apparatus embodiments described above are merely illustrative. For example, the division and definition of the units are based on logical functions, while in various implementations; the units may be divided in different ways, such as combing multiple units or components, integrated to another system, or omitting some features. In other instances, it may include coupling or directly coupling of the components shown or discussed. The information or data connection may refer to an indirect coupling or a communication connection of the apparatus or units through a plurality of interfaces, either in an electrical connection, a mechanical connection, or other forms.

The units described above may or may not be physically separated. The display unit may or may not be a physical unit. In some embodiments, the processor and the display unit may be arranged in one display apparatus. In some embodiments, the processor and the display unit may be distributed over a plurality of network elements. It is apparent that a part or all the elements may be selected to achieve the purpose of the present embodiments.

In addition, the functional units in the embodiments may be integrated in one processing module, or they may be separated as individual units. Two or more units may be integrated in one unit. The integration of the units can be realized in a hardware form or in a hardware form in combination with various software functional units.

It can be easily understood by those of ordinary skill in the art that all or part of the steps of implementing the method embodiments described above may be accomplished by various hardware components associated with program instructions. Program instructions may be stored in a computer-readable storage medium that. When executed, the program instructions may implement the as described functions. The storage medium may include various media that store program codes. The storage medium may be the storage medium in mobile storage device, a read-only memory (ROM), a random-access memory (RAM), a disk, or an optical disk.

As described above, the disclosed embodiments are exemplary. The scope of the present invention is not limited there to the specific embodiments. Other embodiments of the disclosure would be apparent to those skilled in the art from consideration of the specification and practice of the present disclosure herein. It is intended that the specification and embodiments be considered as exemplary only, with a true scope and spirit of the invention being indicated by the claims.

What is claimed is:

1. An information processing method, comprising:
using a first electronic apparatus to receive data displayed via a second electronic apparatus for a corresponding display via the first electronic apparatus;
providing a status identifier to control the corresponding display of the data as received from the second electronic apparatus; and
displaying the status identifier via the first electronic apparatus.

2. The method according to claim 1, further comprising:
providing a first identifier of a first application executed in the second electronic apparatus as the status identifier; and
displaying the first identifier via the first electronic apparatus.

3. The method according to claim 2, further comprising:
displaying the corresponding display in a first display area via the first electronic apparatus; and
displaying the first identifier in a second display area via the first electronic apparatus, the first display area being different from the second display area.

4. The method according to claim 3, wherein:
the second display area is a display area for displaying an identifier of a task that the first electronic apparatus is executing.

5. The method according to claim 1, further comprising:
displaying, via the first electronic apparatus, a menu after receiving a first operation acting on the status identifier, the menu including an application identifier of the second electronic apparatus, and the application identifier indicating an application of the second electronic apparatus.

6. The method according to claim 5, further comprising:
switching a display interface of the first electronic apparatus from the first application to a second application of the second electronic apparatus after a second operation of selecting the application identifier of the second application is detected.

7. The method according to claim 6, further comprising:
receiving a second identifier of the second application;
updating the status identifier to the second identifier; and
displaying the second identifier.

8. An electronic apparatus, comprising:
a display unit; and
a processor configured to receive data displayed via a remote electronic apparatus for a corresponding display via the display unit;
wherein the processor is further configured to provide a status identifier to control the corresponding display of the data as received from the remote electronic apparatus, and to display the status identifier via the display unit.

9. The electronic apparatus according to claim 8, wherein:
the processor is further configured to provide a first identifier of a first application executed in the remote electronic apparatus as the status identifier; and the display unit is configured to display the first identifier.

10. The electronic apparatus according to claim 9, wherein:
the display unit is further configured to display the corresponding display in a first display area and display the first identifier in a second display area, the first display area being different from the second display area.

11. The electronic apparatus according to claim 10, wherein the second display area is a display area for displaying an identifier of a task that the electronic apparatus is executing.

12. The electronic apparatus according to claim 8, wherein:
the display unit is further configured to display a menu after receiving a first operation acting on the status identifier, the menu including an application identifier of the remote electronic apparatus, and the application identifier indicating an application of the remote electronic apparatus.

13. The electronic apparatus according to claim 12, wherein:
the display unit is configured to switch a display from the first application to a second application of the remote electronic apparatus after a second operation of selecting the application identifier of the second application is detected, the second application being different from the first application.

14. The electronic apparatus according to claim 12, wherein:
the processor is configured to receive a second identifier of the second application as the status identifier; and
the display unit is further configured to display the second identifier.
